(19) United States
(12) Patent Application Publication
(10) Pub. No.: US 2011/0252991 A1
(43) Pub. Date: Oct. 20, 2011

(54) Printable automatic Paper Belt-Rolling reader (PB Reader)

(76) Inventors: Yan Zhang, Weymouth, MA (US); Tianlan Zhang, Hangzhou (CN)

(21) Appl. No.: 13/066,427

(22) Filed: Apr. 14, 2011

Related U.S. Application Data
(60) Provisional application No. 61/324,037, filed on Apr. 14, 2010.

(51) Int. Cl. B41F 21/00

(52) U.S. Cl. 101/407.1

(57) ABSTRACT

The PB Reader solves the problem that the e-reader presents: the e-reader has a non-paper screen and printed documents need assembly, binding, and page turning via hands.

This is an electronic, mechanical device that can quickly search, review and print documents and that has text-to-speech and remote control functionality. The unit is rectangular in shape similar as a traditional book, including a viewing window for reading and printing. The unit is fed by two paper-belt rollers, across which images and printed text are displayed. The two paper-belt rolls, which are held by two square axles that are driven by the stepping motor through multiple reduction gears. A pattern of round dots is printed on the bottom side of the paper belt, which can be decoded by a photoelectric sensor to take action of reeling pages. The signals control the stepper motor, allowing the reader to reel the page forward or backward, or jump directly to a specific position.

The second component of this invention is the designated printer. Its body shape is rectangular. The said printer can print any text files and photos from a computer directly onto the blank paper belt in the PB Reader by means of sensing the code on the paper belt. This way, electronic files are transformed into physical paper files that are readable by the invention to ensure quick search, review and as well as safe storage.

The invention also has a wireless remote control function, which will allow people who are disabled (or users who for whatever reasons do not have free use of their hands) to make use of the reader.

### CROSS-REFERENCE TO RELATED APPLICATIONS

This application claims the benefits of U.S. Provisional Patent Application No. 61324037, filed Apr. 14, 2010, which is incorporated in its entirety by reference herein.

### BACKGROUND OF THE INVENTION

1. Technology Field

This is an electronic, mechanical device with its main body composed of two paper scrolls (paper belt-rolls) that can quickly search, review and print documents with the feature of providing sound along with reading (Text-to-Speech feature) and remote control functionality, which traditional paper version books do not have.

The said device displays documents that are presented as text printed on a paper belt to provide the same satisfaction and closeness obtained from reading a traditional, paper-version book.

The said device is comprised of a Printable Automatic Paper Belt-Rolling Reader (“PB Reader”) and a Designated Printer that can print text files and photos from a computer directly onto the blank paper belt in the PB Reader by means of sensing the code on the paper belt.

The PB Reader can also be connected to a computer to upload information onto an SDHC card which is inserted in the PB Reader. It can copy and delete documents that are on the SDHC card connected to the computer.

2. Background

Current electronic reader technology uses a digital signal display (as with an electrophoretic or similar displays called e-books), as opposed to letters/characters printed on paper.

This invention overcomes several problems associated with e-books. Such problems include (1) quick onset of eyestrain; (2) lack of the general satisfaction gained from holding a physical book such as using a pen/pencil to make highlights; (3) lack of accessibility and convenience for use by children; (4) high manufacturing costs.

The PB Reader also overcomes the need for turning pages of traditional books by hand. The PB Reader's designated printer eliminates the extra step of paper binding, as is done by traditional printers after documents are printed. The PB Reader presents the documents on a paper belt that is always printed already bound like a scroll.

In contrast to current e-books, the PB Reader uses the mechanical paper roll function and employs a printed paper display instead of using any electronic-digital display panel. (e.g., electrophoretic displays, electroactive displays, reflective bistable displays). Yet the PB Reader fulfills the e-book's functions such as moving pages forward, backward or skipping pages yet can be made at a much lower cost than e-books.

### SUMMARY OF THE INVENTION

This is an electronic, mechanical device that can quickly search, review and print documents and that has text-to-speech and remote control functionality. The unit is rectangular in shape similar as a traditional book, including a viewing window for reading and printing. The unit is fed by two paper rolls, across which images and printed text are displayed. The two paper rolls are vertically placed into the rear part of the device's rectangular body: one roll is attached to left side and the other is attached to right side. (See FIG. 1) The two paper rolls can be replaced with new rolls through opening the rear cover of the PB reader. The PB Reader has two paper-belt rolls, which are held by two square axles that are driven by the stepping motor through multiple reduction gears. A pattern of round dots is printed on the bottom side of the paper belt, which can be decoded by a photoelectric sensor to take action of reeling pages. The signals control the stepper motor, allowing the reader to reel the page forward or backward, or jump directly to a specific position.

The second component of this invention is the designated printer. Its body shape is rectangular. The said printer can print any text files and photos from a computer directly onto the blank paper belt in the PB Reader by means of sensing the code on the paper belt. This way, electronic files are transformed into physical paper files that are readable by the invention to ensure quick search, review and as well as safe storage.

With the text-to-speech and SDHC Card features in the invention, one can also use the PB Reader to make her/his own photo album with music at home. For example, a user can upload information from his/her computer onto an SDHC card. The SDHC card can be inserted into a PB Reader's SDHC card jack to allow an MP3 Audio file to play via speakers on the PB Reader.

The invention also has a wireless remote control function, which will allow people who are disabled (or users who for whatever reasons do not have free use of their hands) to make use of the reader.

This invention has applications in the following scenarios:
Electronic-Mechanical Teaching Books
Electronic-Mechanical Note Book (with a choice of setting up keys/passwords)
Electronic-Mechanical Calendar
Electronic-Mechanical Accounting Book (with a choice of setting up keys/passwords)
Electronic-Mechanical Music Notes
Electronic-Mechanical Map
Electronic-Mechanical Files
Electronic-Mechanical Braille books (with Dedicated Braille printing)
Electronic-Mechanical Photo Album

### BRIEF DESCRIPTION OF THE DRAWINGS

These and other aspects of the invention will now be further described, by way of example only, with reference to the accompanying figures:

FIG. 1 shows a perspective view of a PB Reader's mechanical structure in accordance with the invention;

FIG. 2 shows a representation of a portable type printer in accordance with the invention;

FIG. 3 shows a representation of a paper-belt roll structure with suggested measurements in accordance with the invention;

FIG. 4 shows a perspective view of the portable reading device with suggested measurements in accordance with the invention;

FIG. 5 shows a representation of a remote control wireless device operated by one's heel in accordance with the invention;

FIG. 6 shows, in block diagram form, the PB Reader's principle electric circuit map in accordance with the invention.

### DETAILED DESCRIPTION OF A PREFERRED EMBODIMENT

We will describe an electronic mechanic Paper Belt-Rolling reading device (“PB Reader”) composed of pages incorporating ink text-print displays, with an integrated printer and a remote controller.

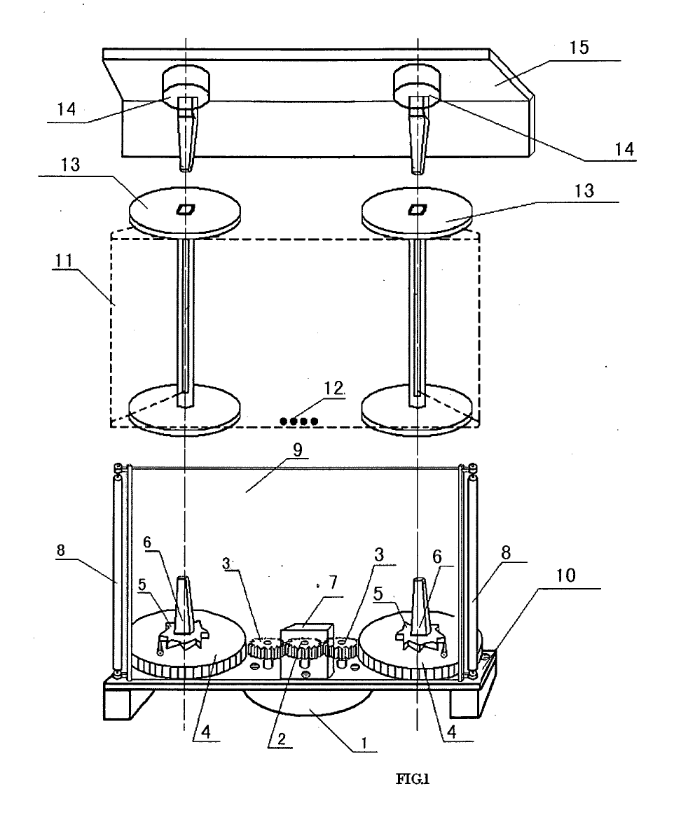

FIG. 1 shows a representation of the portable type PB Reader that has a fixed base 10. On the base there are two objective/active axles 6 on the left and right side (one axle on each side). In the center of the base 10, there is a motor gear 2 connected to two middle gears 3, which are linked to two big gears 4 with the decelerated ratio of 1:2:3.

The ratchet mechanisms 5 will automatically release the paper clip when the stepper motor 1 turns backwards.

The PB Reader has an enclosure decoder/photoelectric sensor 7 to decode the round-shape code 12 printed on the bottom of the paper belt 11 (which is represented as dash line on the drawing) controlled by digital circuits to enable the motor to reel the paper belt page forward or backward, stop, jump to a specific page.

The rollers 8 are made of nylon, with bearings inside to let the paper belt to pass smoothly. The paper holding board 9 is made of plastic to ensure the paper belt is taut, flat and smooth. The upper ⅔ part of the rear cover 15 of the PB reader can be removed to replace and install paper-belt rolls. There are two passive axles 14 on the top left and right sides of the back cover 15, which are used to fasten the paper-belt roll 13.

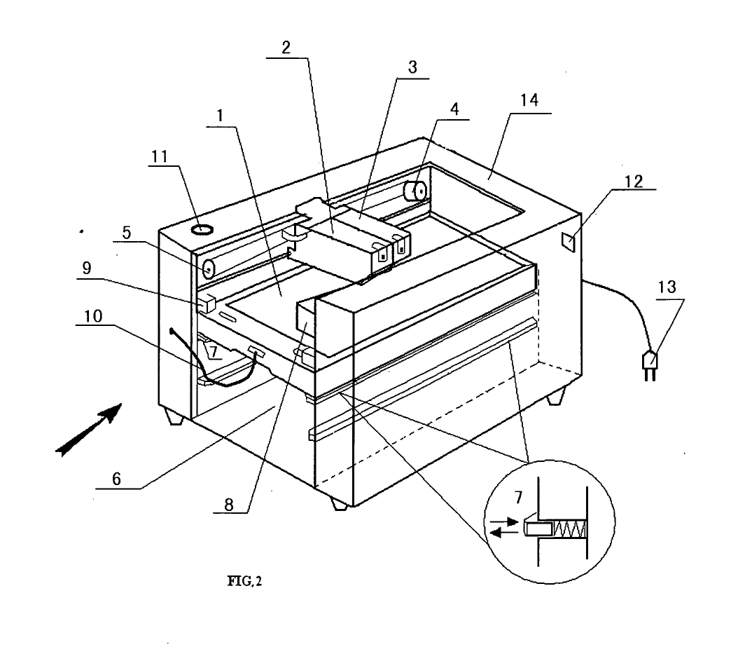

FIG. 2 shows a representation of the designated portable type printer 14 for the PB Reader. On the top section of the printer there are two ink cartridges: one cartridge is color ink 2 and the other contains black ink 3. The printer also involves a cartridge drive motor 4 and a cartridge move belt 5.

When printing, the user (1) inserts the PB Reader 1 equipped with a blank paper-belt roll into the “printing center receptacle space” 6 on the tracks 7. (2) Connects the printing cable line 10 between the printer and the PB reader 1. The printing center receptacle space 6 is designed as multi-layer space combined with the flexible tracks 7 which have springs behind them in order to go in and out to accommodate the different thickness of the PB Reader 1. (Please see the amplified drawing on the bottom right side). The operating method of the printer is the same as other printers on the market today.

There is also a mini, electric calorifier/dryer 8 installed in the printer 14 to dry the paper while paper rolls through the PB Reader. The position-fasten control equipment 9 will keep the PB Reader 1 in a fixed position for printing.

The portable type printer 14 has a USB jack 12, a power switch 11 and a power plug 13.

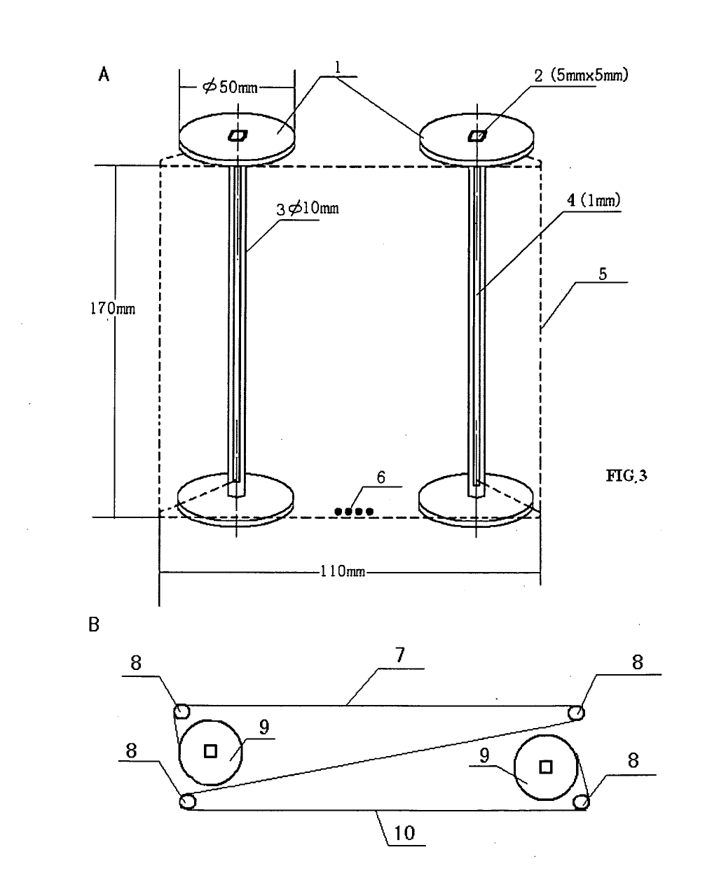

FIG. 3 shows a representation sample of a detailed drawing of the mechanical principle of the PB Reader with suggested measurements.

Drawing A. The two paper-belt rollers 1 of the PB Reader are made of plastic, containing a slot 4 in each of the intermediate spindles 3 to connect the lead of the paper belt 5. The code 6 contains the round dots are printed on the bottom edge of the paper belt.

The two square holes 2 on the paper-belt rollers 1 are connected to passive axles on the rear cover.

The paper-belt rollers 1, each has a diameter of 50 mm (≈1.97 inches). The special paper is 0.10 mm (≈00.004 inches) thick. The total length of the rolled paper on the belts is 25 meters (≈82 feet). The maximum viewing range of the paper is 110 mm (≈4.33 inches), which will make 227 pages (25000/110=227). If printed with 12-point font, the space of 227 pages can print an approximate total of 153,225 letters (with each page printing 675 letters×227 pages=153,225) or 180 photos. Each single page has a space of 150 mm (≈6 inches)×100 mm (≈4 inches).

The above calculation is an example of the paper-belt for single-side printing and reading. It can also develop into a module II that prints and reads on both side of the paper-belt as shown in drawing B.: Paper-belt front side 7, Roller 8, Paper-belt rollers 9, Paper-belt back side 10.

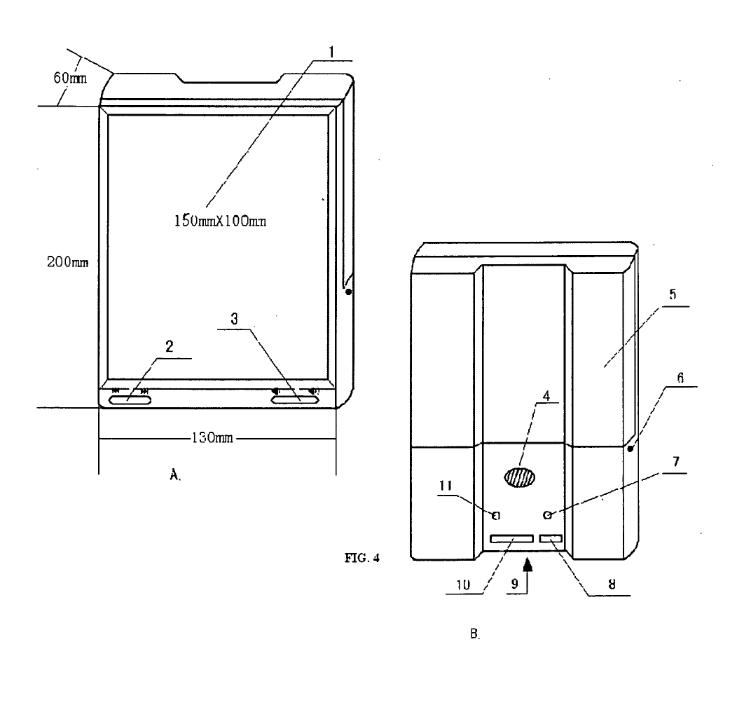

FIG. 4 shows a representation of appearance of the portable type PB Reader in accordance with the invention. Drawing A: Front view and Drawing B: Back view.

On the front side of the PB Reader, the reader's view window 1 is 110 mm (≈4.33 inches) ×150 mm (≈6 inches). The reader's page-control buttons (left and right) 2 are used to make the page go forward (right), backward (left) or stop. Continuing to press the page-control buttons 2 causes the paper to go forward (right) or backward (left); pressing once will cause the paper to turn one page forward (right) or backward (left). The volume control buttons 3 are to adjust the volume as necessary (left one for lower volume, right one for higher volume).

On the back side of the reader there is a speaker 4, rear cover 5, USB jack 8, printing jack 9, SDHC Card jack 10, switch 11 and power recharge jack 7.

When opening the rear cover locker 6, the upper rear cover 5 will be opened to expose ⅔ paper rolls to change new paper-belt rolls.

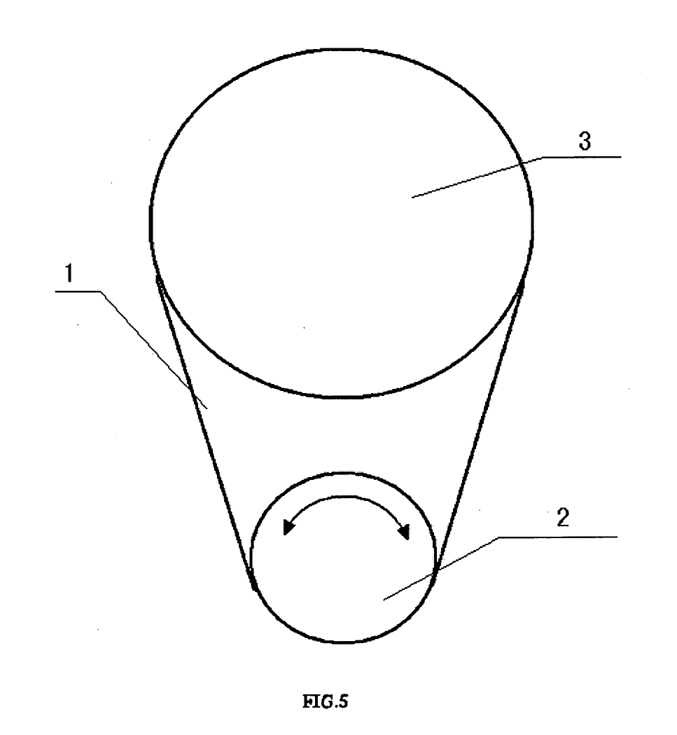

FIG. 5 shows a representation of the remote control wireless device 1 operated by one's heel in accordance with the invention. This remote control is controlled by the user's heel, pressing and turning the switch 2, turning it to the left to make pages go backward and turning it to right to make pages go forward. The user will press the heel on the middle of the remote control to stop motion of the paper. Because the switch 2 has springs, it will return to neutral when the user releases pressure from the device.

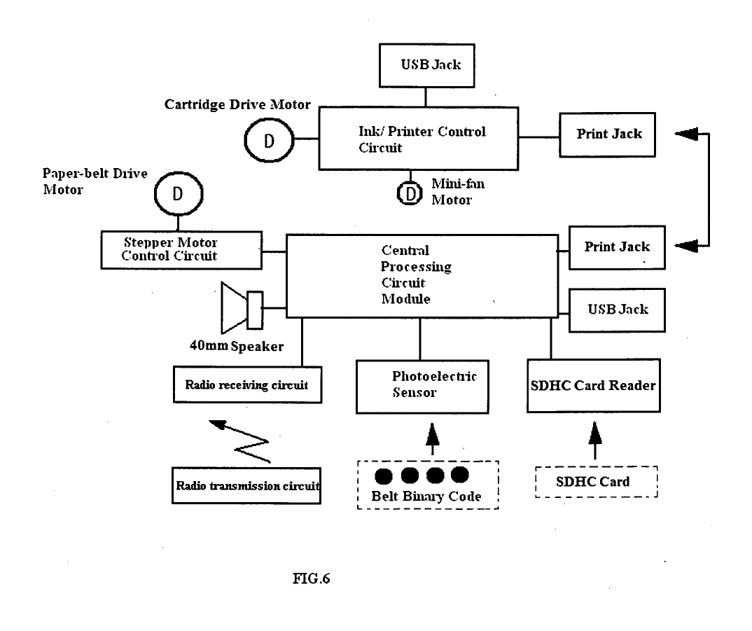

FIG. 6 shows, in block diagram form, the PB Reader's principle electric circuit map in accordance with the invention. The control circuit applies a large-scale integrated circuit (LSI) module. Radio transmission and receiving uses micro-integrated circuit modules (Its operating frequency is 250-300 MHz). The decoder/photoelectric sensor use photoelectric binary sensors. The card reader function allows one to copy or delete files on SDHC card connected to a computer. The processing circuit module includes the following circuits: Encoding circuit, Decoding circuit, Counting circuit, Distribution circuit module, Amplifier module, Switch circuit module and Delay circuit module.

### DETAILED DESCRIPTION OF THE INVENTION

The PB Reader solves the problem that the e-reader presents: the e-reader has a non-paper screen and printed documents need assembly, binding, and page turning via hands.

This invention uses special durable paper onto which text is printed. It can provide text-to-speech functions to user for either recreational reading or as a study aid. The page-turning remote control function allows people with disabilities (or people who, for whatever reason, do not have use of their hands) to use the device.

This invention applied two forms of technology:

(1) The PB Reader has the shape of a traditional book. The unit has a viewing window on the front side for reading. The unit is fed by two paper-belt rollers: one on the left side and one on the right side, across which images and text are displayed on the viewing window. The two paper-belt rollers are placed vertically into the back side of the PB Reader by opening the rear cover. Through the rear cover, the paper rolls can be taken off, changed and replaced. The paper scrolls can be stored as traditional books. The paper-belt rolls are also extended to their maximum viewing range when fixed in place by the paper-belt holding board (see FIG. 1-9) and left and right roller (see FIG. 1-8).

Installed in the device are two sets of paper-roll axles on both the life and right sides. The left side roll axles are used for holding the paper roll (sending paper). The right side roll axles are for receiving the paper.

The ratchet mechanism ensures the left spool will release the holding clip to allow the paper belt to reel to the right, driven by the active square axle powered by the stepper motor.

The motion of scrolling the paper-belt rollers is controlled by the encoding dots printed on the bottom edge of the paper belt. This signal input is picked up and interpreted by a decode system which controls the stepper motor.

The said paper belt is made from a special strong paper. The said viewing window does not have any cover, so the reader can read, make underlines/notes and touch the paper belt in order to feel the personal connection and closeness many have with a traditional book.

(2) The second component of this invention is the designated printer. Its body shape is rectangular. The top section of the printer has two ink cartridges; one cartridge is color ink and the other contains black ink. The printer is capable of receiving PB reader of various thicknesses. This is made possible because the tracks on both sides of the printer receptacle area have numerous latches installed in different tiers.

It is ready for printing by connecting the print jack of the PB Reader to the printer's connector cable. The printed text is displayed on the paper roll from left to right on the said PB Reader. There is a mini dryer installed in the printer to dry the paper, which will continuously roll into the PB Reader while printing. This printer represents the following advantages over the common printer used nowadays: (a) the printer won't jam paper; (b) no paper binding will be needed.

There are two methods for using the said PB Reader: (a) one can read the PB Reader by using the ready-printed paper-belt roll in it; (b) one can also place the said PB reader with blank paper-belt roll into the said printing center to print any content one likes from the computer.

The special paper used for the paper belt has the following characteristics: it is thin, light weight, strong, durable and hard to tear. Tyvek Spunbonded olefin sheet products from Dupont Company are good examples of paper that can be used.

This PB Reader has a remote control function. It applies a wireless radio technology by sending radio frequencies (RF). The remote control feature allows various human control interfaces, such as with the foot or chin, allowing the PB reader to be a handicap-friendly device. The PB reader is powered by a 12 V DC lithium battery. The invention-PB Reader has a card reader and a USB jack which can be connected to a computer to download files. The said printer also has a USB jack that can connect to a computer to print. The said printer will come with directions to provide step by step printing instructions (i.e., please insert PB reader in to printer, start to print, printing finished etc . . . )

The benefits of the said PB Reader unit are

(1) Electronic files and documents can be printed continuously on the paper-belt roll. This will allow the user to quickly read and search the documents. It also provides better, safe and long-lasting storage than traditional paper books or paper files because of the special kind of paper that is used.

(2) There is a text-to-speech feature that enables out-loud-reading capabilities or fun reading possibilities with featured background music.

(3) A remote control function provides convenience for people who need this function or any needed occasions.

(4) The printing function of inserting the PB reader into the printer eliminates the need of binding.

The skilled person will understand that references to a document or a file here are to be interpreted broadly and include (but are not limited to) newspapers, books, emails, attachments, web pages, markup language documents, written music, images, and other graphical representations; for example, comics.

The skilled person will understand that a document reading device of the type described above is not restricted to documents in any particular language such as English and may, for example, be used with languages with different script reading and/or page turning directions, such as Arabic, Chinese and Japanese.

It will be understood that the invention is not limited to the described embodiments and encompasses modifications apparent to those skilled in the art lying within the spirit and scope of the claims appended hereto.

What is claimed is:

1. (a) An electronic mechanic Paper Belt-Rolling reading device including a viewing window on the front side for viewing & printing and a rear cover to open, insert, remove, change and reinsert paper-belt roll. (b) The electronic, mechanical paper-belt reading device has two roll axles on both left and right sides of the device for installing the paper-belt rollers. The left side roll axle is for holding the paper roll (to send paper). The right side roll axle is for receiving the paper. (c) In order to obtain a fixed viewing range, the reading device has a rigid holding board to ensure that the paper belt is taut (see FIG. 1-9), and the ratchet mechanism under the axles is to ensure that left side of the paper belt is released from the clip while the stepper motor drives the mechanism. (d) A code composed of patterns of round dots is printed on the bottom side of the paper belt. The code is decoded by a photoelectric sensor via digital circuits, which engages the motor, causing the PB Reader to move the pages forward or backward, stop, and jump to a specific page. The said code system also engages the PB Reader's text-to-speech functionality. (e) The PB Reader printer is rectangular in shape. The top part has both black and color ink cartridge attached to its tracks. The lower part of the printer is the receptacle area which has the same width as the PB Reader with two tracks that interfaces with it. Users insert the reader via left and right side tracks into the “printing center receptacle space” when printing needed. The insert track is flexible to accommodate a variety of reader thicknesses. (f) The upper portion of the said printer provides printing and the bottom space of the said printer is for inserting the PB Reader that controls the motion of the paper belt to roll from left to right. There is a mini dryer installed in the printer to dry the paper while ready-printed paper is rolling in the reader.

2. An electronic mechanic Paper Belt-Rolling reading device as claimed in claim 1 (a) wherein said viewing window is on the front side of the device for viewing & printing.

3. An electronic mechanic Paper Belt-Rolling reading device as claimed in claim 1 (b). The said device has two paper-belt rolls, one of which sends the paper belt, and one of which receives the paper belt. In contrast, if the motor rolls in a different direction, the above said rolls will change their rolling direction as well.

4. An electronic mechanic Paper Belt-Rolling reading device as claimed in claim 1 (c) wherein said paper-belt is extended to its maximum viewing range by the use of the hold board behind the paper belt (see FIG. 1-9) and the left and right roller (see FIG. 1-8).

5. An electronic mechanic Paper Belt-Rolling reading device as claimed in claim 1 (d) wherein the said reading device has a code system that is composed of patterns of round dots printed on the bottom side of the paper belt. The codes are decoded by a photoelectric sensor controlled by digital circuits to engage the motor, causing the reader to move the paper belt page forward or backward, stop, or jump to a specific page. The code is a form of binary input command. The code system on the PB Reader also allows downloading MP3 audio files from a computer to the PB Reader via inserting the SDHC card to engage the Text-to-Speech functionality.

6. An electronic mechanic Paper Belt-Rolling reading device as claimed in claim 1 (e) wherein said designated printer is configured to print. The printer includes a printing center into which the PB Reader can be inserted along the flexible tracks.

7. An electronic mechanic Paper Belt-Rolling reading device as claimed in claim 6. The PB Reader's printer has two tracks with multi track layers that are designed as attaching springs behind the tracks so the tracks can freely go in and out to accommodate the different thickness of the said PB reader.

8. An electronic mechanic Paper Belt-Rolling device as claimed in claim 1 (f) wherein said printer provides printing from left to right. The upper portion of the said printer provides printing and the bottom space of the said printer is for inserting the PB Reader that controls the motion of the paper belt to roll from left to right.

9. An electronic mechanic Paper Belt-Rolling device as claimed in claim 1 (f) wherein There is a mini dryer installed in said printer to dry the paper while the paper rolls through the reader.
